(19) United States
(12) Patent Application Publication
(10) Pub. No.: US 2022/0260431 A1
(43) Pub. Date: Aug. 18, 2022

(54) Temperature Measurement Method and Program

(71) Applicant: Nippon Telegraph and Telephone Corporation, Tokyo (JP)

(72) Inventors: Daichi Matsunaga, Tokyo (JP); Yujiro Tanaka, Tokyo (JP); Michiko Seyama, Tokyo (JP)

(21) Appl. No.: 17/596,073

(22) PCT Filed: Jun. 4, 2019
(86) PCT No.: PCT/JP2019/022155

§ 371 Date: Dec. 2, 2021

(51) Int. Cl. G01K 13/20; G01K 7/22; G01K 15/00

(52) U.S. Cl. CPC G01K 13/20; G01K 15/005; G01K 7/22

(57) ABSTRACT

An embodiment is a temperature measurement method. The physical quantities related to a temperature of a living body are measured. A deep part body temperature of the living body is estimated using a coefficient and the measured physical quantities. An index is calculated using the measured physical quantities and the estimated deep part temperature. In a case in which the value of the index exceeds a threshold value, the coefficient is calibrated. It is thus possible to estimate the deep part body temperature more accurately regardless of a change in convection state of ambient air.

### CROSS-REFERENCE TO RELATED APPLICATION

This application is a national phase entry of PCT Application No. PCT/JP2019/022155, filed on Jun. 4, 2019, which application is hereby incorporated herein by reference.

### TECHNICAL FIELD

The present disclosure relates to a temperature measurement method for measuring a temperature at a deep part of a substance and a program for causing a computer to execute the method.

### BACKGROUND

There are temperature regions in substances such as living bodies that are not affected by changes in ambient temperature or the like over certain depths from the skin to deep parts. The temperatures of the regions are called deep part body temperatures or core part temperatures. On the other hand, temperatures of living body surfaces that are likely to be affected by changes in ambient temperature are called body surface temperatures. Body surface temperatures can be measured by transdermal thermometers. Body temperatures measured by transdermal thermometers may not reflect deep part body temperatures. It is thus difficult to transdermally measure deep part body temperatures like body surface temperatures. Although deep part body temperatures are important living body information, measurement techniques in the related art are invasive and have large measurement loads, and it is thus difficult to perform continuous measurement.

Thus, techniques of estimating deep part body temperatures using body surface temperatures measured by temperature sensors on the assumption of heat equivalence circuits in which processes of heat transmission in living bodies are replaced with electrical circuits have been proposed. Techniques of this type are disclosed in Non Patent Literature 1, for example.

FIG. 11 is a block diagram of a related living body internal temperature measurement device. This living body internal temperature measurement device is adapted to estimate a deep part body temperature of a living body by a dual heat flux method and includes two probes 111a and 111b. These probes 111a and 111b are disposed on the surface of a living body 130. The probe 111a has a heat insulating member with a thermal resistance R_{S1} and measures body surface temperatures T_{S1} and T_{S3} via the heat insulating member (R_{S1}). The probe 111b has a heat insulating member with a thermal resistance R_{S2} that is different from the thermal resistance R_{S1} and measures body surface temperatures T_{S2} and T_{S4} via the heat insulating member (R_{S2}).

The heat fluxes H_{S1} and H_{S2} of the probes 111a and 111b, respectively, are obtained by Equations (1a) and (1b), respectively.

H_{S1}=(T_{S1}−T_{S3})/R_{S1} (1a)

H_{S2}=(T_{S2}−T_{S4})/R_{S2} (1b)

The deep part body temperature T_{C} is represented by Equations (2a) and (2b). Here, R_{B} denotes a thermal resistance of a living body, which is an unknown value.

T_{C}=T_{S1}+R_{B}·H_{S1} (2a)

T_{C}=T_{S2}+R_{B}·H_{S2} (2b)

If R_{B} is eliminated from Equations (2a) and (2b), Equation (3) is obtained.

$${T}_{C} = \frac{{T}_{S 2} \cdot {H}_{S 1} - {T}_{S 1} \cdot {H}_{S 2}}{{H}_{S 1} - {H}_{S 2}} \qquad ( 3 )$$

It is possible to estimate the deep part body temperature T_{C} using Equation (3). However, because each piece of tissue constituting the living body 130 is actually joined to pieces of tissue in a direction parallel to the body surface as well, leakage H_{L} of the heat flux occurs. The leakage H_{L} of the heat flux occurs inside the living body 130, and it is thus not possible to measure the leakage H_{L}. Non Patent Literature 1 thus discloses a technique of performing calibration in estimation of the deep part body temperature T_{C} to estimate the deep part body temperature T_{C} more accurately.

As illustrated in FIG. 12, the heat fluxes α₁H_{S1} and α₂H_{S2} of the living body 130 are obtained by adding the leakages H_{L1} and H_{L2} of the heat fluxes to the heat fluxes H_{S1} and H_{S2} of the probes 111a and 111b, respectively. Here, α₁ and α₂ are proportions of the leakages H_{L1} and H_{L2} of the heat fluxes with respect to the heat fluxes H_{S1} and H_{S2} of the probes 111a and 111b, respectively. α₁ and α₂ are defined by ratios of the heat fluxes α₁H_{S1} and α₂H_{S2} of the living body 130 with respect to the heat fluxes H_{S1} and H_{S2} of the probes 111a and 111b, respectively.

Equations (4a) and (4b) representing the deep part body temperature T_{C} in consideration of the leakages H_{L1} and H_{L2} of the heat fluxes are obtained by replacing H_{S1} and H_{S2} in Equations (2a) and (2b) with α₁H_{S1} and α₂H_{S2}.

T_{C}=T_{S1}+R_{B}·α₁H_{S1} (4a)

T_{C}=T_{S2}+R_{B}·α₂H_{S2} (4b)

Equation (5) is obtained if R_{B} is eliminated from Equations (4a) and (4b). However, the coefficient K is a variable called “the proportion of leakages of heat fluxes of the two sensors (probes 111a and 111b)” and is represented by the ratio (K=α₁/α₂) between α₁ and α₂.

$${T}_{C} = \frac{K \cdot {T}_{S 2} \cdot {H}_{S 1} - {T}_{S 1} \cdot {H}_{S 2}}{K \cdot {H}_{S 1} - {H}_{S 2}} \qquad ( 5 )$$

It is possible to estimate the deep part body temperature T_{C} in consideration of the leakages H_{L1} and H_{L2} of the heat fluxes using Equation (5). The coefficient K is calibrated with a reference value T_{Cref(0)} of the deep part body temperature T_{C} acquired in advance as illustrated in Equation (6).

$${K}_{( 0 )} = \frac{( {T}_{Cref ( 0 )} - {T}_{S 1 ( 0 )} ) / {H}_{S 1 ( 0 )}}{( {T}_{Cref ( 0 )} - {T}_{S 2 ( 0 )} ) / {H}_{S 2 ( 0 )}} \qquad ( 6 )$$

### CITATION LIST

### Non Patent Literature

Non Patent Literature 1: J. Feng, C. Zhou, C. He, Y. Li, X. Ye, “Development of an Improved Wearable Device for Core Body Temperature Monitoring Based on the Dual Heat Flux Principle”, Med. Eng. Phys., vol. 38, no. 4, pp. 652 to 668, April 2017.

### SUMMARY

### Technical Problem

However, the related living body internal temperature measurement device has a problem that an error occurs in the estimated value of the deep part body temperature T_{C} if a convection state of ambient air changes due to influences of wind and the like.

Thus, an object of the present disclosure is to provide a temperature measurement technique that enables a deep part temperature of a substance to be more accurately estimated regardless of changes in a convection state of ambient air.

### Means for Solving the Problem

In order to solve such a problem, a temperature measurement method according to an embodiment of the present disclosure includes measuring physical quantities related to a temperature of a substance, estimating a deep part temperature of the substance using a coefficient that is calibrated and the physical quantities that are measured, calculating an index using the physical quantities that are measured and the deep part temperature that is estimated, and calibrating the coefficient using the physical quantities that are measured and a reference value of a deep part temperature in a case in which a value of the index that is calculated exceeds a threshold value.

Also, a program according to an embodiment of the present disclosure causes a computer to execute measuring physical quantities related to a temperature of a substance, estimating a deep part temperature of the substance using a coefficient that is calibrated and the physical quantities that are measured, calculating an index using the physical quantities that are measured and the deep part temperature that is estimated, and calibrating the coefficient using the physical quantities that are measured and a reference value of a deep part temperature in a case in which a value of the index that is calculated exceeds a threshold value.

### Effects of Embodiments of the Invention

According to embodiments of the present disclosure, the index is calculated using the measured physical quantities and the estimated deep part temperature, and in a case in which the value of the index exceeds a threshold value, the coefficient used in the estimation of the deep part temperature is calibrated. The coefficient is thus calibrated at a timing at which an estimation error of the deep part temperature occurs due to a change in convection state of ambient air. The estimation error is reduced by estimating the deep part temperature of the substance using the thus calibrated coefficient. According to embodiments of the present disclosure, it is thus possible to estimate the deep part temperature more accurately regardless of a change in convection state of ambient air.

### BRIEF DESCRIPTION OF DRAWINGS

FIG. 1 is a block diagram illustrating a configuration of a living body internal temperature measurement device according to an embodiment of the present disclosure.

FIG. 2 is a block diagram illustrating a configuration of a measurement unit.

FIG. 3 is a block diagram illustrating a configuration of an arithmetic operation unit.

FIG. 4 is a functional block diagram of the arithmetic operation unit

FIG. 5 is a diagram illustrating a relationship between an index for detecting a calibration timing and an estimation error of a deep part body temperature.

FIG. 6 is a flowchart illustrating a flow of processing based on a living body internal temperature measurement method according to the embodiment of the present disclosure.

FIGS. 7A and 7B are diagrams illustrating a heat equivalence circuit of the living body internal temperature measurement device.

FIG. 8 is a graph illustrating influences of wind on a coefficient and an estimated value of a deep part body temperature of a living body.

FIGS. 9A to 9D are graphs illustrating results of an experiment of repeatedly performing recalibration of the coefficient.

FIG. 10 is a graph in which estimation errors are compared between a case in which the recalibration is performed on the coefficient and a case in which the recalibration is not performed thereon.

FIG. 11 is a block diagram of a related living body internal temperature measurement device.

FIG. 12 is a block diagram illustrating leakage of a heat flux.

### DESCRIPTION OF EMBODIMENTS

Hereinafter, an embodiment of the present disclosure will be described in detail with reference to the drawings.

### Configuration of Temperature Measurement Device

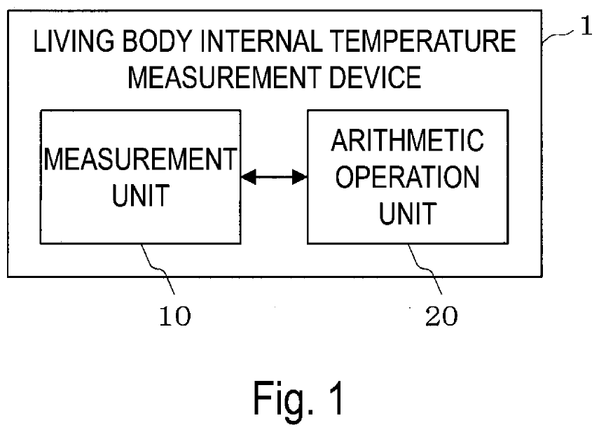

As illustrated in FIG. 1, a living body internal temperature measurement device 1 according to an embodiment of the present disclosure includes a measurement unit 10 that measures physical quantities related to a temperature of a living body 30 and an arithmetic operation unit 20 that performs an arithmetic operation of a deep part body temperature (deep part temperature) of the living body 30 using the physical quantities output from the measurement unit 10. The physical quantities related to the temperature of the living body 30 include a surface temperature and a heat flux of the living body 30.

### Configuration of Measurement Unit

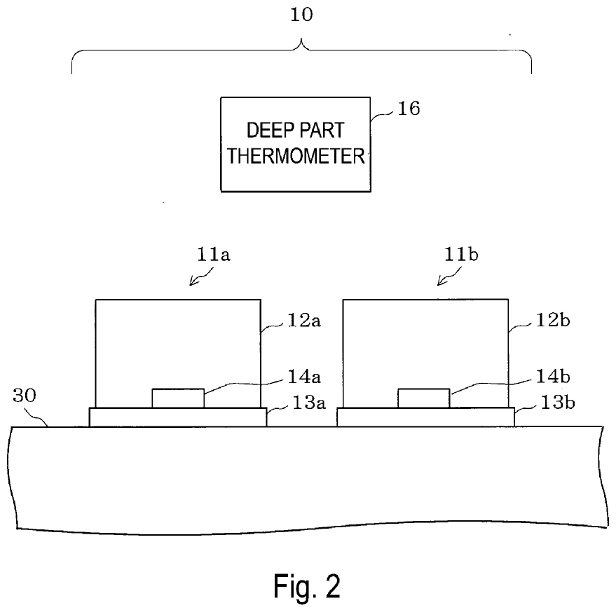

As illustrated in FIG. 2, the measurement unit 10 includes two probes (a first probe and a second probe) 11a and 11b. The probes 11a and 11b include heat insulating members (a first thermal resistor and a second thermal resistor) 12a and 12b, heat flux sensors (a first heat flux measurement unit and a second heat flux measurement unit) 13a and 13b, and temperature sensors (a first temperature measurement unit and a second temperature measurement unit) 14a and 14b, respectively.

The heat insulating members 12a and 12b configure thermal resistors and have mutually different thermal resistance values. In the present embodiment, the heat insulating members 12a and 12b have the same rectangular parallelepiped shapes formed of mutually different materials. The heat insulating members 12a and 12b may be formed to have mutually different thermal resistance values using heat insulating material that are different materials from each other and/or that have different thicknesses.

The heat flux sensors 13a and 13b are devices that measure heat fluxes (a first heat flux and a second heat flux) H_{S1} and H_{S2}, respectively, that indicate heat movement per unit time and unit area. In the present embodiment, the heat flux sensors 13a and 13b are provided at end portions of the heat insulating members 12a and 12b. The probes 11a and 11b are disposed such that the heat flux sensors 13a and 13b come into contact with the surface of the living body 30 when the deep part body temperature of the living body 30 is measured.

The temperature sensors 14a and 14b are devices that measure temperatures (a first surface temperature and a second surface temperature) T_{S1} and T_{S2}, respectively, at the surface (skin) of the living body 30. In the present embodiment, the temperature sensors 14a and 14b are provided on the heat flux sensors 13a and 13b. The temperature sensors 14a and 14b can be configured with thermistors, thermocouples, resistance temperature detectors, or the like.

The measurement unit 10 includes a deep part thermometer 16. The deep part thermometer 16 is a device that measures a reference value T_{Cref} of the deep part body temperature of the living body 30 used to calibrate a coefficient K, which will be described below. The deep part thermometer 16 is configured with a thermometer that measures a temperature at an eardrum or an inner ear, for example. The temperature measured by a thermometer of this type is used as the reference value T_{Cref} of the deep part body temperature.

### Configuration of Arithmetic Operation Unit

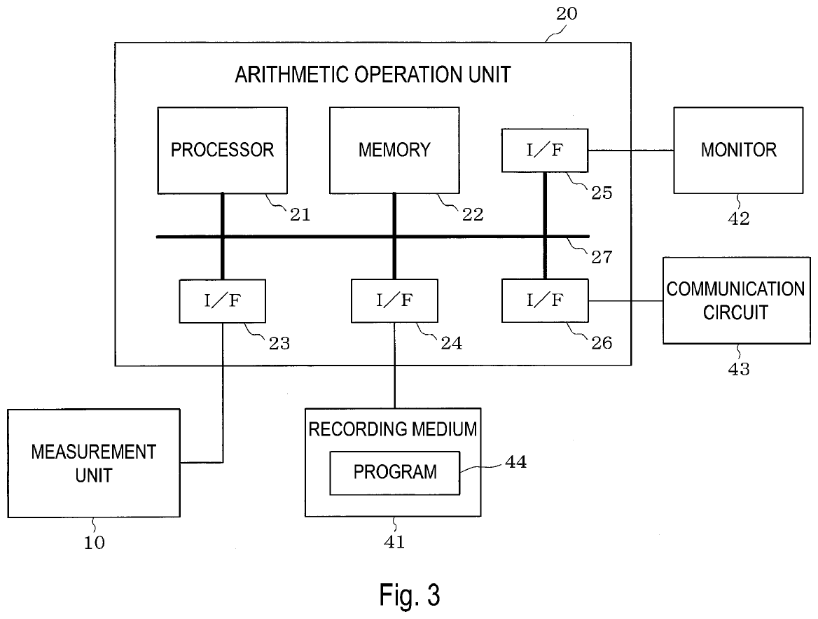

The arithmetic operation unit 20 is configured with a computer. As illustrated in FIG. 3, the arithmetic operation unit 20 includes a processor 21, a memory 22, and I/F circuits 23, 24, 25, and 26. These elements 21 to 26 are connected to each other via a bus 27.

The processor 21 is configured with, for example, a central processing unit (CPU) or a digital signal processor (DSP). The memory 22 is configured of a storage device such as a read only memory (ROM), a random access memory (RAM), and a flash memory.

The I/F circuit 23 is an interface of the aforementioned measurement unit 10. The I/F circuit 24 is an interface of a non-transitory computer readable recording medium (non-transitory computer readable medium) 41. As the recording medium 41, it is possible to use an optical disc such as a compact disc (CD) or a digital versatile disc (DVD), or an external memory, for example.

The I/F circuit 25 is an interface of a monitor 42. An I/F circuit 43 is an interface of a communication circuit 43. The communication circuit 43 may be an input/output circuit to which a cable of a standard such as universal serial bus (USB) is to be connected or a wireless communication circuit in accordance with Bluetooth (trade name) or the like.

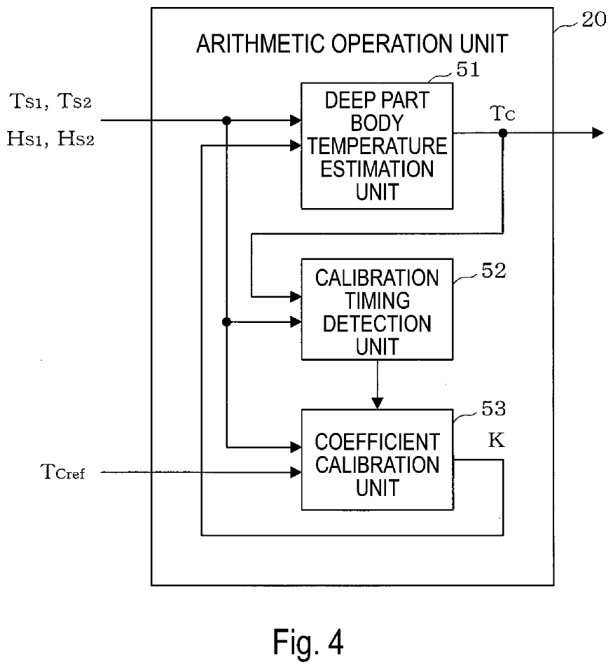

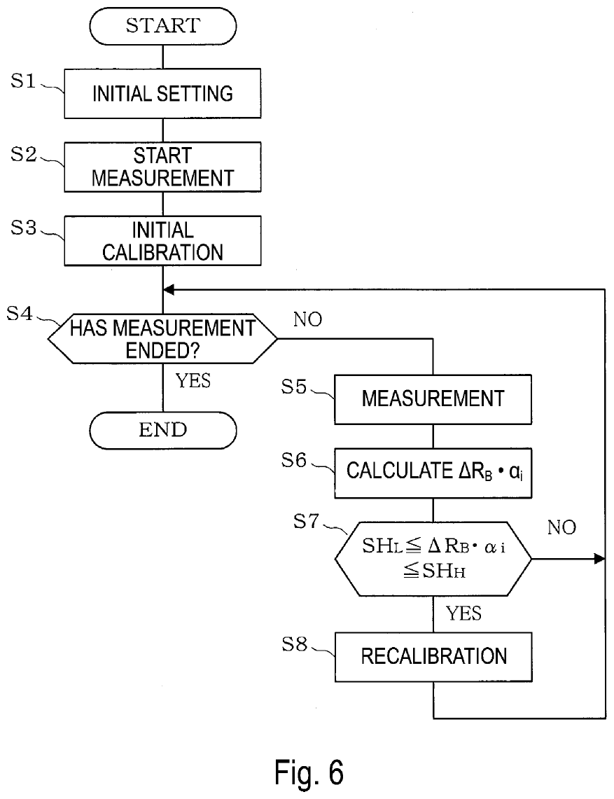

A program 44 according to the embodiment of the present disclosure is provided in a state in which the program 44 is recorded in a recording medium 40. Alternatively, the program 44 can also be provided through an electrical communication line. The provided program 44 is stored in the memory 22 by the processor 21. Also, functional units as illustrated in FIG. 4 are implemented, and a series of processing operations as illustrated in FIG. 6 are executed, by the processor 21 operating in accordance with the program 44.

### Functions of Arithmetic Operation Unit

If the arithmetic operation unit 20 is considered in terms of functions, the arithmetic operation unit 20 includes a deep part body temperature estimation unit 51, a calibration timing detection unit 52, and a coefficient calibration unit 53 as illustrated in FIG. 4.

The deep part body temperature estimation unit 51 is a functional unit that estimates the deep part body temperature of the living body 30 using the physical quantities output from the measurement unit 10 and the calibrated coefficient. Specifically, the deep part body temperature estimation unit 51 estimates the deep part body temperature T_{C} of the living body 30 from Equation (5) described above using the surface temperatures T_{S1} and T_{S2} and the heat fluxes H_{S1} and H_{S2} of the living body 30 measured by the probes 111a and 111b and the coefficient K (=α₁/α₂). The surface temperatures T_{S1} and T_{S2} and the heat fluxes H_{S1} and H_{S2} are output at constant sampling intervals. Although the deep part body temperature T_{C} can also be estimated at the intervals, the coefficient K calibrated at a timing that will be described below is used.

The deep part body temperature estimation unit 51 generates and outputs time-series data of the estimated deep part body temperature T_{C} of the living body 30. The time-series data is data in which a measurement clock time and the estimated deep part body temperature T_{C} are associated with each other. The time-series data output from the deep part body temperature estimation unit 51 is displayed on the monitor 42 or is output to the outside through the communication circuit 43.

The calibration timing detection unit 52 is a functional unit that detects the timing at which the coefficient K is calibrated. More specifically, the calibration timing detection unit 52 calculates an index using the physical quantities (T_{S1}, T_{S2}, H_{S1}, and H_{S2}) output from the measurement unit 10 and the deep part body temperature T_{C} of the living body 30 estimated by the deep part body temperature estimation unit 51 and provides an instruction for calibrating the coefficient K to the coefficient calibration unit 53, which will be described below, at a timing at which the value of the index exceeds a threshold value.

In the present embodiment, ΔR_{B}·αᵢ (i=1, 2) is used as the index. ΔR_{B}·αᵢ is a change rate of R_{B}·αᵢ (=current R_{B}·αᵢ/R_{B}·αᵢ when the coefficient K was calibrated last time). R_{B} is a thermal resistance of the living body 30. αᵢ is a proportion of leakages H_{L1} and H_{L2} of the heat fluxes with respect to the heat fluxes H_{S1} and H_{S2} of the probes 111a and 111b, respectively. αᵢ is defined by the ratio of the heat fluxes α₁H_{S1} and α₂H_{S2} of the living body 30 with respect to the heat fluxes H_{S1} and H_{S2} of the probes 11a and 11b, respectively. ΔR_{B}·αᵢ is an index that can be acquired using two or more heat flux sensors (13a and 13b).

ΔR_{B}·αᵢ is obtained by Equations (7a) and (7b).

ΔR_{B}·α₁={(T_{C}−T_{S1})/H_{S1}}/{(T_{C(0)}−T_{S1(0)})/H_{S1(0)}} (7a)

ΔR_{B}·α₂={(T_{C}−T_{S2})/H_{S2}}/{(T_{C(0)}−T_{S2(0)})/H_{S2(0)}} (7b)

Equations (7a) and (7b) are obtained by deforming Equations (4a) and (4b). However, (T_{C(0)}−T_{S1(0)})/H_{S1(0)} is (T_{C}−T_{S1})/H_{S1} when the coefficient K is calibrated last time. Thus, the index ΔR_{B}·αᵢ can be expressed as a change rate of (T_{C}−T_{S1})/H_{S1} with reference to the time when the coefficient K is calibrated last time.

Both ΔR_{B}·α₁ and ΔR_{B}·α₂ may be used as indexes. However, because ΔR_{B}·α₁ and ΔR_{B}·α₂ change in similar manners, using either ΔR_{B}·α₁ or ΔR_{B}·α₂ as an index is sufficient.

There is a case in which variations occur in the value of ΔR_{B}·αᵢ due to a change in convection state of ambient air. Thus, a plurality of values of ΔR_{B}·αᵢ calculated in a predetermined period in the past may be averaged, and the average value of ΔR_{B}·αᵢ may be regarded as an index and compared with a threshold value.

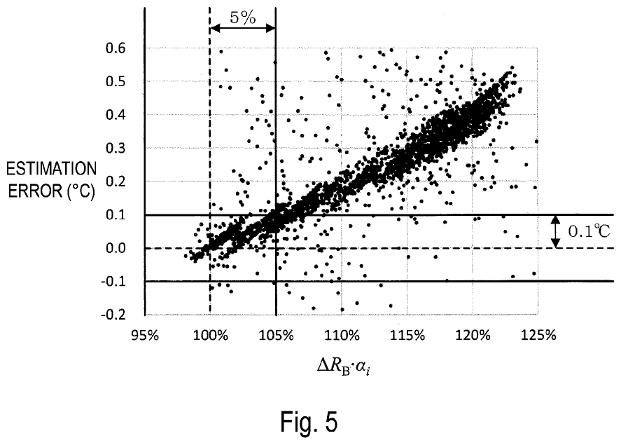

The threshold value of the index ΔR_{B}·αᵢ depends on an ambient temperature, required accuracy that is different for each application, and structures of the probes 11a and 11b. Through prior verification of the living body internal temperature measurement device 1, FIG. 5 illustrating a relationship between ΔR_{B}·αᵢ and an estimation error (° C.) of the deep part body temperature T_{C} of the living body 30 were given. It is possible to ascertain from FIG. 5 that if required accuracy (required error range) of an application is set to 0.1° C., the estimation error increases when ΔR_{B}·αᵢ exceeds ±5%. Thus, 5% is set as a threshold value in the present embodiment.

The coefficient calibration unit 53 is a functional unit that recalibrates the coefficient K in response to an instruction from the calibration timing detection unit 52. The coefficient calibration unit 53 calibrates the coefficient K using the physical quantities (T_{S1}, T_{S2}, H_{S1}, and H_{S2}) output from the measurement unit 10 and the reference value T_{Cref} of the deep part body temperature of the living body 30 occasionally output from the measurement unit 10. The coefficient calibration unit 53 recalibrates the coefficient K using Equation (6). Note that the coefficient calibration unit 53 also performs initial calibration of the coefficient K using Equation (6).

### Temperature Measurement Method

Next, operations of the living body internal temperature measurement device 1 will be described as a living body internal temperature measurement method according to the embodiment of the present disclosure with reference to FIG. 6. Here, it is assumed that ΔR_{B}·α₁ is used as an index for detecting a timing at which the coefficient K is calibrated.

An operator places the probes 11a and 11b in an aligned manner on the surface of the living body 30 such that the heat flux sensors 13a and 13b of the probe 11a and 11b, respectively, come into contact with the surface of the living body 30 in advance. Then, the operator inputs, as initial setting, the threshold value of the index for detecting a timing at which the coefficient K is calibrated using an input device (not illustrated) of the arithmetic operation unit 20. In the present embodiment, an upper limit threshold value SH_{H} of ΔR_{B}·α₁ is set to “1.05” (=5%), and a lower limit threshold value SH_{L} of ΔR_{B}·α₁ is set to “0.95” (=−5%). The processor 21 stores the reference value T_{Cref(0)} of the deep part body temperature and the threshold value in the memory 22 (Step S1).

If the operator provides an instruction for starting measurement of the deep part body temperature using the input device (Step S2), then the processor 21 first causes the probes 11a and 11b to start to measure the surface temperatures T_{S1} and T_{S2} and the heat fluxes H_{S1} and H_{S2} of the living body 30, respectively. Thereafter, the measurement values of the surface temperatures T_{S1} and T_{S2} and the heat fluxes H_{S1} and H_{S2} are output from the probes 11a and 11b, respectively, at constant sampling intervals. Note that the measurement of the surface temperatures T_{S1} and T_{S2} and the heat fluxes H_{S1} and H_{S2} corresponds to “measuring physical quantities related to a temperature of a substance” in embodiments of the present disclosure.

The processor 21 then performs initial calibration of the coefficient K (Step S3). Specifically, the processor 21 obtains a coefficient K₍₀₎ by assigning the surface temperatures T_{S1(0)} and T_{S2(0)} and the heat fluxes H_{S1(0)} and H_{S2(0)} output from the probes 11a and 11b, respectively, immediately after the start of measurement and the reference value T_{Cref(0)} of the current deep part body temperature acquired by the deep part thermometer 16 for initial calibration to Equation (6) and stores the coefficient K₍₀₎ as the coefficient K in the memory 22. The initial calibration of the coefficient K is a function of the coefficient calibration unit 53 in FIG. 4.

If there is no instruction for ending the measurement from the operator (Step S4; NO), then the processor 21 performs estimation (measurement) of the deep part body temperature T_{C} of the living body 30 using the coefficient K after initial calibration (Step S5). Specifically, the processor 21 obtains the deep part body temperature T_{C} by assigning the surface temperatures T_{S1} and T_{S2} and the heat fluxes H_{S1} and H_{S2} output from the probes 11a and 11b, respectively, and the coefficient K stored in the memory 22 to Equation (5). The deep part body temperature T_{C} is displayed on the monitor 42 or is output to the outside through the communication circuit 43. Note that the estimation of the deep part body temperature T_{C} of the living body 30 is a function of the deep part body temperature estimation unit 51 in FIG. 4 and corresponds to “estimating a deep part temperature of the substance using a coefficient that is calibrated and the physical quantities that are measured” in embodiments of the present disclosure.

In order to calculate the index ΔR_{B}·α₁, which will be described below, the processor 21 stores the deep part body temperature T_{C} of the living body 30 estimated immediately after the calibration of the coefficient K as T_{C(0)} and the surface temperature T_{S1} and the heat flux H_{S1} used for the estimation of the deep part body temperature T_{C} as T_{S1(0)} and H_{S1(0)} in the memory 22. The processing is performed not only after the initial calibration but also after recalibration, which will be described below.

The processor 21 calculates the index for detecting the timing at which the coefficient K is calibrated (Step S6). Specifically, the processor 21 first reads, from the memory 22, the deep part body temperature T_{C(0)}, the surface temperature T_{S1(0)}, and the heat flux H_{S1(0)} when the coefficient K is calculated. The processor 21 assigns these data items, the deep part body temperature T_{C} of the living body 30 measured immediately before in Step S5, and the surface temperature T_{S1} and the heat flux H_{S1} used for the measurement of the deep part body temperature T_{C} to Equation (7a) to obtain the index ΔR_{B}·α₁. Note that the calculation of the index ΔR_{B}·α₁ is a function of the calibration timing detection unit 52 in FIG. 4 and corresponds to “calculating an index using the physical quantities that are measured and the deep part temperature that is estimated” in embodiments of the present disclosure.

The processor 21 then reads the upper limit threshold value SH_{H} “1.05” and the lower limit threshold value SH_{L} “0.95” of the index ΔR_{B}·α₁ from the memory 22 and compares the value of the index ΔR_{B}·α₁ obtained in Step S6 with the threshold value. As a result, if the value of ΔR_{B}·α₁ is equal to or greater than 0.95 and equal to or less than 1.05 (Step S7; NO), the processing returns to Step S4, and the processor 21 continues the estimation (measurement) of the deep part body temperature T_{C} of the living body 30 until the operator provides an instruction for ending the measurement.

In a case in which the value of the index ΔR_{B}·α₁ obtained in Step S6 exceeds the threshold value in Step S7, that is, in a case in which the value of ΔR_{B}·α₁ is greater than 1.05 or smaller than 0.95 (Step S7; YES), the processor 21 determines that the timing at which the coefficient K is to be calibrated is reached and performs the recalibration of the coefficient K (Step S8). Specifically, the processor 21 obtains the coefficient K₍₀₎ by assigning the reference value T_{Cref(0)} of the current deep part body temperature acquired by the deep part thermometer 16 for recalibration and the surface temperatures T_{S1(0)} and T_{S2(0)} and the heat fluxes H_{S1(0)} and H_{S2(0)} output from the probes 111a and 111b, respectively, immediately before to Equation (8) and updates the coefficient K stored in the memory 22 with the coefficient K₍₀₎. Note that the recalibration of the coefficient K is a function of the coefficient calibration unit 53 in FIG. 4 and corresponds to “calibrating the coefficient using the physical quantities that are measured and a reference value of a deep part temperature in a case in which a value of the index that is calculated exceeds a threshold value” in embodiments of the present disclosure.

Thereafter, the processing returns to Step 4, and the processor 21 continues to estimate (measure) the deep part body temperature T_{C} of the living body 30 again until the operator provides an instruction for ending the measurement. If the operator provides an instruction for ending the measurement (Step S4; YES), the processor 21 ends the series of processing operations for measuring the deep part body temperature T_{C}.

Note that in a case in which an average value of a plurality of ΔR_{B}·α₁ values is used as an index, the processor 21 stores ΔR_{B}·α₁ in the memory 22 every time ΔR_{B}·α₁ is calculated and calculates an average of a predetermined plural number of ΔR_{B}·α₁ values in order from the latest one to obtain the average value in Step S6. Then, the processor 21 compares the average value of the plurality of ΔR_{B}·α₁ values with the threshold value in Step S7.

### Experiment Results

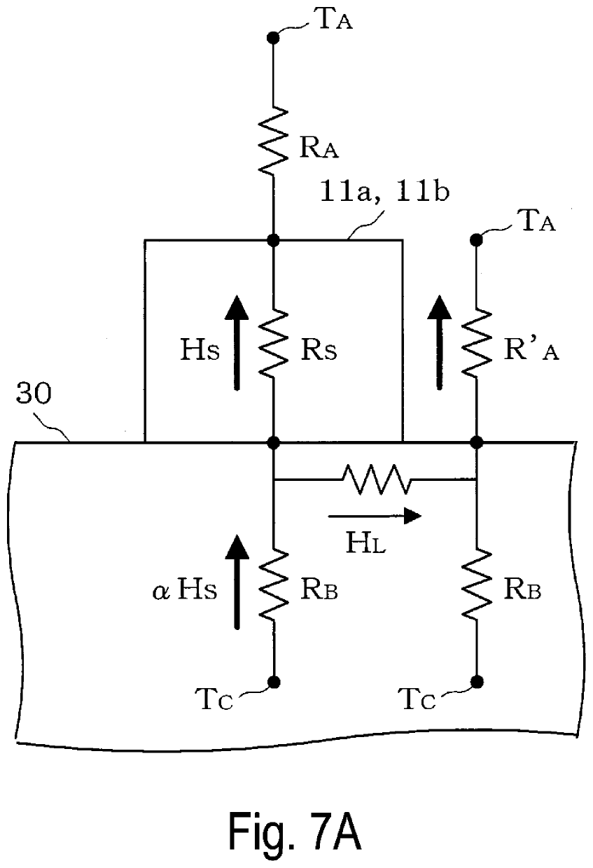

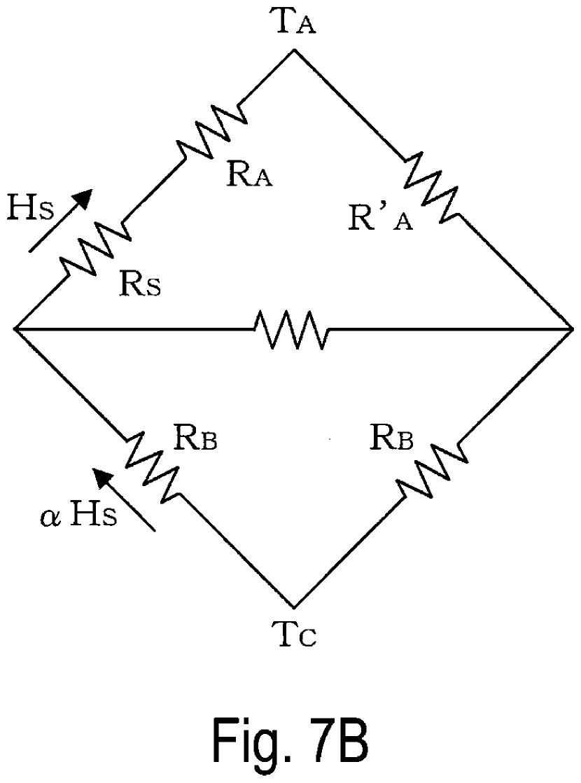

In the living body internal temperature measurement device 1, the probes 111a and 111b and thermal resistances in the surroundings thereof are joined to each other as illustrated in FIG. 7A to form a bridge circuit as illustrated in FIG. 7B. The bridge circuit includes a thermal resistance R_{A} against ambient air. It is considered to be, if a convection state of the ambient air changes due to influences of wind and the like, the thermal resistance R_{A} against the ambient air changes, and the proportions α₁ and α₂ (“a” in the drawing) of the leakages H_{L1} and H_{L2}, respectively, of the heat fluxes change. If α₁ and α₂ change, then the coefficient K, which is a ratio between α₁ and α₂ also changes. It is considered to be if the deep part body temperature T_{C} is estimated using the coefficient K₍₀₎ after the initial calibration regardless of this fact, an error occurs in the estimated value. Note that in FIGS. 7A and 7B, T_{A} is an ambient temperature and R′_{A} is a thermal resistance against the ambient air.

Thus, in the present embodiment, occurrence of an error in the estimated value of the deep part body temperature T_{C} is detected using ΔR_{B}·α₁ or ΔR_{B}·α₂ as an index, and the coefficient K is recalibrated at the detected timing to reduce the error. In order to verify effects of the present embodiment, the following experiment using phantom was carried out.

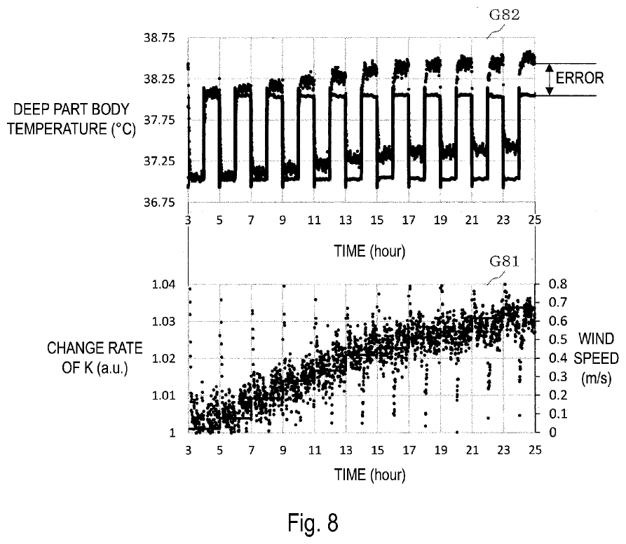

First, influences of wind on the coefficient K and the estimated value of the deep part body temperature T_{C} of the living body 30 were examined. The graph G81 in the lower part in FIG. 8 represents a change in coefficient K due to wind. The horizontal axis represents a time (hour) while the vertical axis represents a change rate (=K/K₍₀₎) (a.u.) of the coefficient K. When the wind speed increases with time, the change in coefficient K with respect to the coefficient K₍₀₎ after initial calibration increases.

The graph G82 in the upper part in FIG. 8 represents a change in estimated value of the deep part body temperature T_{C} of the living body 30 due to wind in a case in which recalibration of the coefficient K is not performed. The horizontal axis represents a time (hour) while the vertical axis represents the deep part body temperature T_{C}. The deep part body temperature T_{C} actually applied to the phantom is illustrated as the reference value T_{Cref} by the thick line. Here, a model in which the deep part body temperature T_{C} repeated fluctuation, namely increases and decreases every one hour was used. The estimated value of the deep part body temperature T_{C} obtained from Equation (5) without recalibration of the coefficient K is represented by dots. It is possible to ascertain that if the coefficient K₍₀₎ after initial calibration is continuously used even after the change in coefficient K increases, a difference (estimation error) between the estimated value and the reference value T_{Cref} increases.

Next, an experiment was carried out in regard to a case in which the coefficient K was recalibrated as described in the present embodiment. The conditions as those in the experiment in FIG. 8 were used other than that the coefficient K was recalibrated. An average value of ΔR_{B}·αᵢ was used as an index for detecting a recalibration timing, and the threshold value was set to “±5%”.

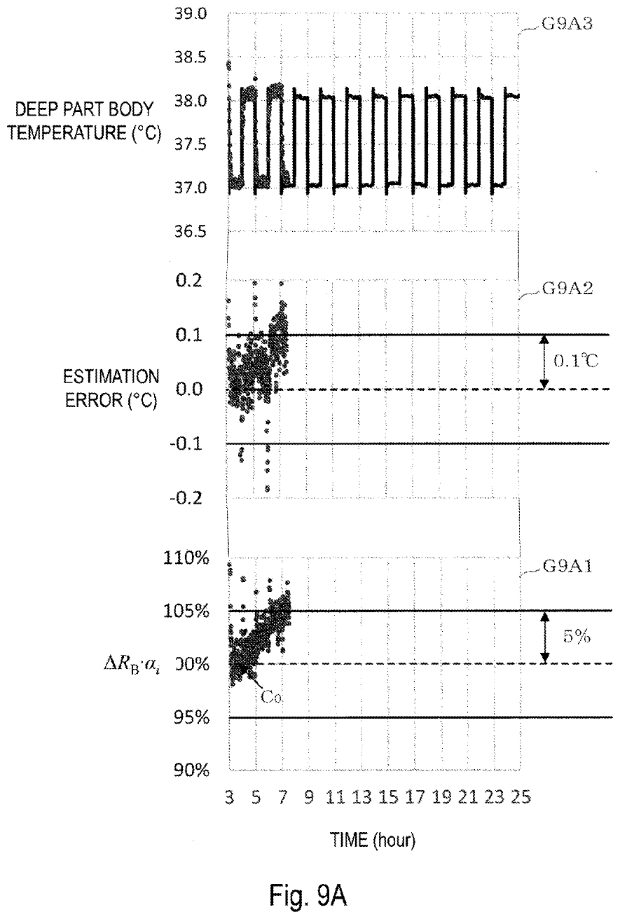

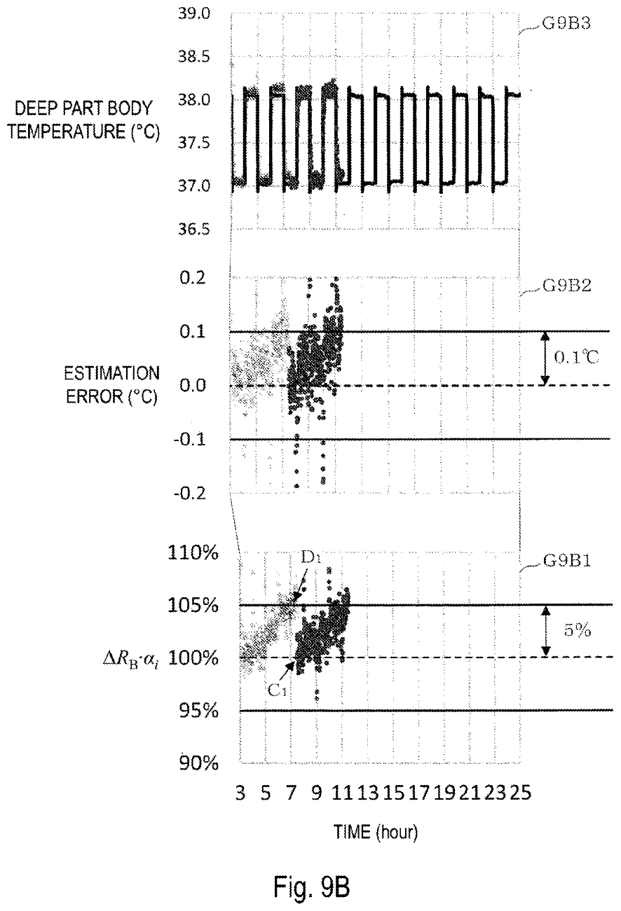

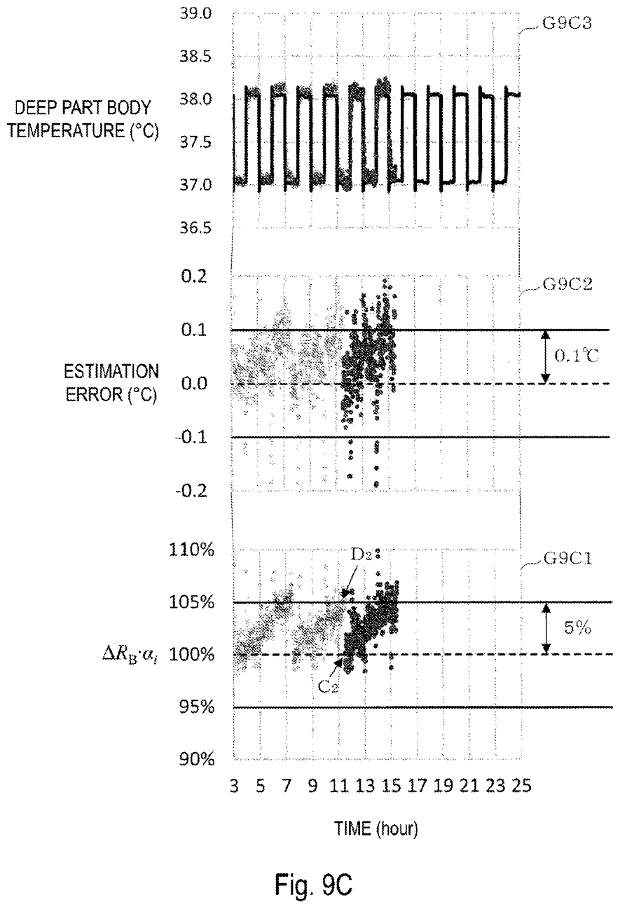

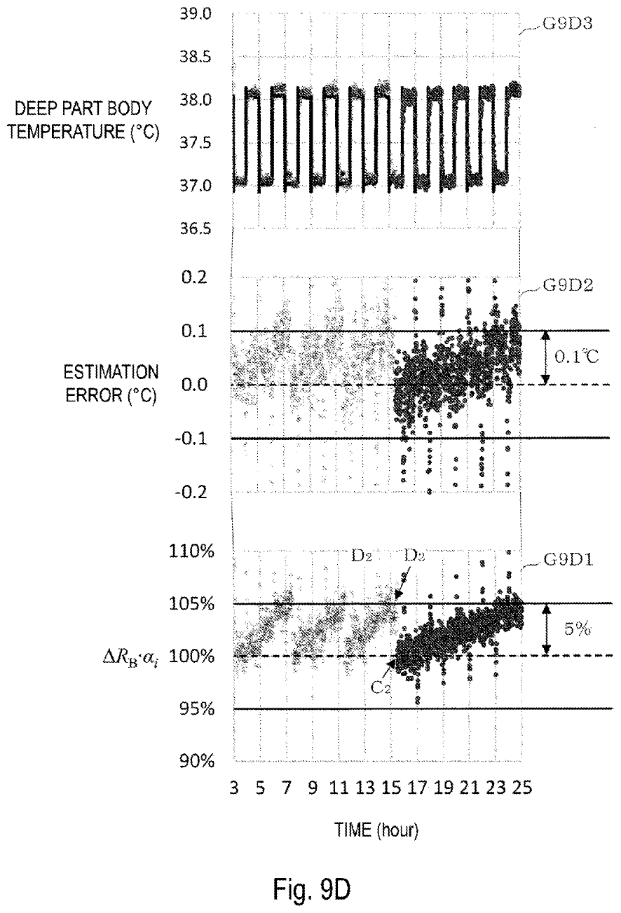

FIG. 9A illustrates an experiment result from the start of the measurement to a timing before the first recalibration. FIG. 9B illustrates an experiment result from a timing after the first recalibration to a timing before the second recalibration. FIG. 9C illustrates an experiment result from a timing after the second recalibration to a timing before the third recalibration. FIG. 9D illustrates an experiment result after the third recalibration.

In regard to FIGS. 9A to 9D, the graphs G9A1, G9B1, G9C1, and G9D1 in the lower parts illustrate changes in ΔR_{B}·αᵢ with a change in wind (convection of ambient air). The graphs G9A2, G9B2, G9C2, and G9D2 at the centers illustrate differences (estimation errors) between estimated values of the deep part body temperature T_{C} and the reference values T_{Cref}. The graphs G9A3, G9B3, G9C3, and G9D3 in the upper parts illustrate estimated values (dots) and the reference values T_{Cref} (thick lines) of the deep part body temperature T_{C}.

The initial calibration is performed on the coefficient K at the point C₀ in FIG. 9A. Thereafter, ΔR_{B}·αᵢ and the estimation error increase with time. However, if the average value of ΔR_{B}·αᵢ exceeding the threshold value “5%” is detected at the point D₁ in FIG. 9B, the first recalibration is performed on the coefficient K at the point C₁. In this manner, the estimation error that reaches around 0.1° C. once decreases around 0° C. Thereafter, if the average value of ΔR_{B}·αᵢ exceeding the threshold value “5%” is detected at the point D₂ in FIG. 9C again, the second recalibration is performed on the coefficient K at the point C₂. If the average value of ΔR_{B}αᵢ exceeding the threshold value “5%” is detected at the point D₃ in FIG. 9D again, the third recalibration is performed on the coefficient K at the point C₃.

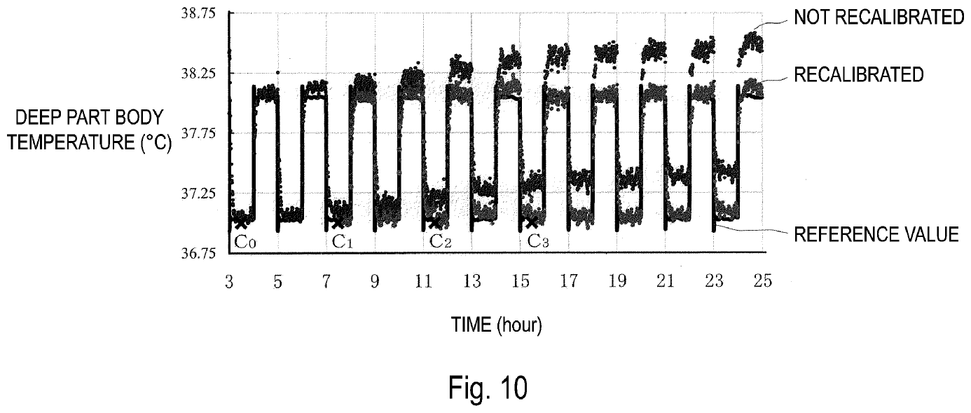

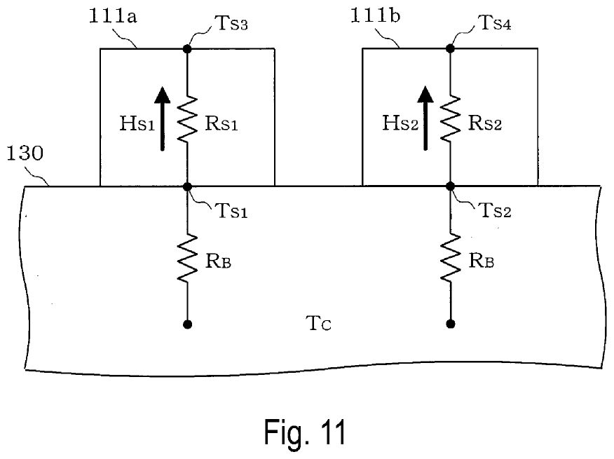

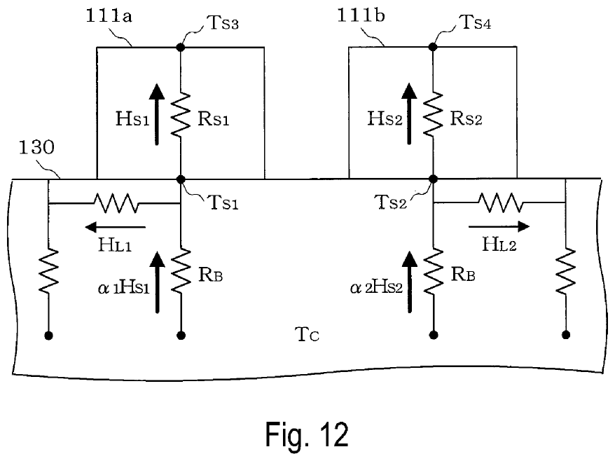

FIG. 10 is a graph in which estimation errors are compared between a case in which the recalibration is performed on the coefficient K and a case in which the recalibration is not performed thereon. The estimation error in the case in which the recalibration is performed is represented with light color dots while the estimation error in the case in which the recalibration is not performed is represented with dark color dots. Also, the reference value T_{Cref} is represented by the thick line. If the recalibration of the coefficient K is not performed, the estimation error increases as the wind speed increases as illustrated in FIG. 8. In contrast, the increase in estimation error is curbed by successively performing the recalibration of the coefficient K even if the wind speed increases. Specifically, it was possible to reduce the estimation error in a steady state (30 minutes later than the deep part body temperature T_{C} varied) to be equal to or less than 0.1° C.

As can be seen in FIGS. 9A to 9D, and 10, interrelation is observed between ΔR_{B}·αᵢ and the estimation error of the deep part body temperature T_{C} of the living body 30. It is thus possible to detect occurrence of an error in the estimated value of the deep part body temperature T_{C} using ΔR_{B}·αᵢ as an index.

In the present embodiment, it is determined that the estimation error of the deep part body temperature T_{C} has occurred if the index ΔR_{B}·αᵢ exceeds the threshold value ±5%. In the present embodiment, the recalibration of the coefficient K is performed at a timing at which the index ΔR_{B}·αᵢ exceeds the threshold value ±5% and the occurrence of the error is detected. The estimation error is reduced by estimating the deep part body temperature T_{C} of the living body 30 using the recalibrated coefficient K.

In the present embodiment, it is possible to successively perform the detection of occurrence of an error and the recalibration of the coefficient K by using ΔR_{B}·αᵢ as the index. Because the estimation error of the deep part body temperature T_{C} of the living body 30 is thus reduced, it is possible to estimate the deep part body temperature T_{C} more accurately regardless of a change in convection state of ambient air in the present embodiment.

### Effects of Embodiment

The living body internal temperature measurement method according to the present embodiment includes measuring physical quantities (T_{S1}, T_{S2}, H_{S1}, and H_{S2}) related to a temperature of a substance (30), estimating a deep part temperature (T_{C}) of the substance (30) using a calibrated coefficient (K) and the measured physical quantities (T_{S1}, T_{S2}, H_{S1}, and H_{S2}), calculating indexes (ΔR_{B}·α₁ and ΔR_{B}·α₂) using the measured physical quantities (T_{S1}, T_{S2}, H_{S1}, and H_{S2}) and the estimated deep part temperature (T_{C}), and calibrating the coefficient (K) using the measured physical quantities (T_{S1}, T_{S2}, H_{S1}, and H_{S2}) and a reference value (T_{Cref}) of the deep part temperature in a case in which the calculated values of the indexes (ΔR_{B}·α₁ and ΔR_{B}·α₂) exceed a threshold value.

The measuring may include measuring a first surface temperature T_{S1} and a first heat flux H_{S1} of the substance (30) as the physical quantities using a first probe (11a) provided with a first thermal resistor (12a), and measuring a second surface temperature T_{S2} and a second heat flux H_{S2} of the substance (30) as the physical quantities using a second probe (11b) provided with a second thermal resistor (12b) having a thermal resistance that is different from a thermal resistance of the first thermal resistor (12a).

When the reference value of the deep part temperature is defined as T_{Cref}, the calibrating may include calibrating the coefficient (K) using {(T_{Cref}−T_{S1})/H_{S1}}/{(T_{Cref}−T_{S2})/H_{S2}}.

When a surface temperature of the substance (30) is defined as T_{S}, a heat flux of the substance (30) is defined as H_{S}, and the estimated deep part temperature is defined as T_{C}, the calculating may include calculating a change rate of (T_{C}−T_{S})/H_{S} as the indexes (ΔR_{B}·α₁ and ΔR_{B}·α₂).

Also, a program according to the present embodiment is a program that causes a computer (20) to execute the aforementioned procedures.

In the present embodiment, the indexes (ΔR_{B}·α₁ and ΔR_{B}·α₂) are calculated using the measured physical quantities (T_{S1}, T_{S2}, H_{S1}, and H_{S2}) and the estimated deep part temperature (T_{C}), and the coefficient (K) used in estimation of the deep part temperature (T_{C}) is calibrated in a case in which the values of the indexes (ΔR_{B}·α₁ and ΔR_{B}·α₂) exceed the threshold value. In this manner, the coefficient (K) is calibrated at the timing at which an estimation error of the deep part temperature (T_{C}) occurs due to a change in convection state of ambient air. The estimation error is reduced by estimating the deep part temperature (T_{C}) of the substance (30) using the thus calibrated coefficient (K). It is thus possible to estimate the deep part temperature (T_{C}) more accurately regardless of a change in convection state of the ambient air according to the present embodiment.

### Extension of Embodiment

The example in which the present disclosure is applied to the living body internal temperature measurement technique for measuring a deep part body temperature of the living body 30 has been described above. However, according to embodiments of the present disclosure, it is also possible to measure a deep part temperature of a substance other than the living body 30.

Moreover, |ΔR_{B}·αᵢ₋₁| (an absolute value of “ΔR_{B}·αᵢ₋₁”) may be used as well as ΔR_{B}·αᵢ and an average value of a plurality of ΔR_{B}·αᵢ values, as an index for detecting the timing at which the coefficient K is to be calibrated. The utilization of |ΔR_{B}·αᵢ₋₁| facilitates comparison between the index and the threshold value. Another index which is different from the indexes including ΔR_{B}·αᵢ as described above may be used.

Also, the example in which the reference value T_{Cref} of the deep part body temperature is acquired using the deep part thermometer 16 has been described in the present embodiment. However, estimated values of the deep part body temperature T_{C} measured until the coefficient K is recalibrated after the coefficient K is calibrated include an accurate value of the deep part body temperature T_{C}. It is also possible to use such an estimated value of the deep part body temperature T_{C} as the reference value T_{Cref}. Thus, the deep part thermometer 16 is not an essential component of embodiments of the present disclosure.

### REFERENCE SIGNS LIST

1 Living body internal temperature measurement device
10 Measurement unit
11a, 11b Probe
12a, 12b Heat insulating member
13a, 13b Heat flux sensor
14a, 14b Temperature sensor
20 Arithmetic operation unit
21 Processor
22 Memory
23 to 26 I/F circuit
27 Bus
30 Living body
41 Recording medium
42 Monitor
43 Communication circuit
44 Program, deep part body temperature estimation unit
52 Calibration timing detection unit
53 Coefficient calibration unit

1.-8. (canceled)

9. A temperature measurement method comprising:
measuring physical quantities related to a temperature of a substance;
estimating a deep part temperature of the substance using a coefficient that is calibrated and the physical quantities that are measured;
calculating an index using the physical quantities that are measured and the deep part temperature that is estimated; and
calibrating the coefficient using the physical quantities that are measured and a reference value of the deep part temperature in response to a value of the index that is calculated exceeding a threshold value.

10. The temperature measurement method of claim 9, wherein the measuring comprises:
measuring a first surface temperature T_{S1} and a first heat flux H_{S1} of the substance as the physical quantities using a first probe; and
measuring a second surface temperature T_{S2} and a second heat flux H_{S2} as the physical quantities using a second probe, the second probe different from the first probe.

11. The temperature measurement method of claim 10, wherein the first probe comprises a first thermal resistor, and wherein the second probe comprises a second thermal resistor having a thermal resistance that is different from a thermal resistance of the first thermal resistor.

12. The temperature measurement method of claim 10, wherein when the reference value of the deep part temperature is defined as T_{Cref}, the calibrating comprises calibrating the coefficient using {(T_{Cref}−T_{S1})/H_{S1}}/{(T_{Cref}−T_{S2})/H_{S2}}.

13. The temperature measurement method of claim 9, wherein when a surface temperature of the substance is defined as T_{S}, a heat flux of the substance is defined as H_{S}, and the deep part temperature that is estimated is defined as T_{C}, the calculating comprises calculating a change rate of (T_{C}−T_{S})/H_{S} as the index.

14. A temperature measurement device comprising:
a processor; and
a non-transitory computer readable medium storing a program to be executed by the processor, the program comprising instructions for:
measuring physical quantities related to a temperature of a substance;
estimating a deep part temperature of the substance using a coefficient that is calibrated and the physical quantities that are measured;
calculating an index using the physical quantities that are measured and the deep part temperature that is estimated; and
calibrating the coefficient using the physical quantities that are measured and a reference value of the deep part temperature in response to a value of the index that is calculated exceeding a threshold value.

15. The temperature measurement device of claim 14 further comprising:
a first probe; and
a second probe, the second probe different from the first probe,
wherein the instructions for the measuring comprise instructions for:
measuring a first surface temperature T_{S1} and a first heat flux H_{S1} of the substance as the physical quantities using the first probe; and
measuring a second surface temperature T_{S2} and a second heat flux H_{S2} as the physical quantities using the second probe.

16. The temperature measurement device of claim 15, wherein the first probe comprises a first thermal resistor, and wherein the second probe comprises a second thermal resistor having a thermal resistance that is different from a thermal resistance of the first thermal resistor.

17. The temperature measurement device of claim 15, wherein when the reference value of the deep part temperature is defined as T_{Cref}, and the instructions for the calibrating comprise instructions for calibrating the coefficient using {(T_{Cref}−T_{S1})/H_{S1}}/{(T_{Cref}−T_{S2})/H_{S2}}.

18. The temperature measurement device of claim 14, wherein when a surface temperature of the substance is defined as T_{S}, a heat flux of the substance is defined as H_{S}, and the deep part temperature that is estimated is defined as T_{C}, the instructions for the calculating comprise instructions for calculating a change rate of (T_{C}−T_{S})/H_{S} as the index.
